(19) United States
(12) Patent Application Publication
(10) Pub. No.: US 2005/0198494 A1
(43) Pub. Date: Sep. 8, 2005

(54) Information-processing device, information-processing system, information-processing method, information-processing program, and recording medium

(76) Inventor: Yuki Ishibashi, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/011,141

(22) Filed: Dec. 15, 2004

(30) Foreign Application Priority Data
Dec. 16, 2003 (JP) 2003-417958
Oct. 5, 2004 (JP) 2004-292812

(51) Int. Cl. G06F 12/14; H04L 9/00

(52) U.S. Cl. 713/155; 726/4

(57) ABSTRACT

In an information-processing device connected through a network to external devices which provide predetermined services respectively, and to one or more authentication devices each including an authentication unit which authenticates a user who uses the services of the external devices, service-provision units provide the user with mutually different interfaces to the services of the external devices respectively. An authentication control unit requests, in response to an authentication request from the service-provision units, the user to input user information, and transmits to one of the authentication devices a request for performing an authentication processing based on the user information. An authentication-information management unit associates and manages the user information inputted by the user, requesting-device identification information to identify a requesting service-provision unit, and requested-device identification information to identify uniquely the one of the authentication devices to which the request for performing the authentication processing is transmitted.

### BACKGROUND OF THE INVENTION

1. Field of the Invention

The present invention relates to the information-processing device, the information processing system, the information-processing method, the information-processing program, and the recording medium, which requests the predetermined server to authenticate the user who uses any of the services of the external devices.

2. Description of the Related Art

When using the function (service) currently provided in the predetermined server on the user's terminal, such as PC (personal computer), it is general that the user is requested to input the user information, such as the user name and the password. Based on the inputted user information, the user is authenticated in the server, and the requested service is provided only to the authenticated user. This is performed in order for preventing the unauthorized use of the service by the unauthorized user.

In order to authenticate the user, it is necessary to implement into the server the authentication function which comprises the program (called the authentication engine) which realizes authentication processing, and the data base (called the user information DB (database)) for managing user information.

However, in a network system in which a plurality of servers are connected, if the authentication function is implemented into each of the plurality of servers, the system resources, such as storage devices, are unnecessarily consumed for such implementation, and also the maintenance work becomes complicated.

To obviate the problem, a conventional network system in which the authentication function is implemented only in a single server and other servers request the user's authentication to the server in which the authentication function is implemented is adopted.

FIG. 1 shows the composition of the network system in which the authentication function is implemented in one server collectively.

In FIG. 1, the terminal 501 is a terminal, such as PC (personal computer) which is used by the user. The document-management server 502 and the document-management server 503 are the so-called document-management servers which contain the mutually different document-management databases respectively. The authentication server 504 is the server in which the authentication function is implemented.

In the composition of FIG. 1, it is illustrated that, when the user of the terminal 501 logs onto any of the document-management server 502 and the document-management server 503, the user's authentication is performed by the same authentication server 504.

In the case of the system of FIG. 1, it is possible to attain easy maintenance of the authentication function etc. However, every time the end user of the terminal 501 accesses one of the document-management servers, the user is requested to carry out the complicated logon operation, such as the input of the user name, the password, etc., although the location where the authentication is performed is the same authentication server 504

For example, when the icons for accessing the respective document-management servers are arranged on a display screen on the PC, or when the GUI (graphical user interface) parts for accessing the document-management server 502 and the GUI parts for accessing the document-management server 503 are provided in the integrated environment, it is complicated and unnatural that, when one of the servers is already accessed and another server is to be accessed, the user is requested again to perform the logon operation.

### SUMMARY OF THE INVENTION

An object of the present invention is to provide an improved information-processing device in which the above-described problems are eliminated.

Another object of the present invention is to provide an information-processing device, an information-processing system, an information-processing method, an information-processing program and a recording medium which enable the user to use the services of the plurality of external devices only with the input operation of user information which is performed once.

The above-mentioned objects of the present invention are achieved by an information-processing device which is connected through a network to a plurality of external devices which provide predetermined services respectively, and to one or more authentication devices each including an authentication unit which authenticates a user who uses any of the services of the plurality of external devices, the information-processing device comprising: a plurality of service-provision units providing the user with interfaces to the services of the external devices respectively, the interfaces being mutually different; an authentication control unit requesting, in response to an authentication request from any of the plurality of service-provision units, the user to input user information for authenticating the user, and transmitting to one of the authentication devices a request for performing an authentication processing based on the user information; and an authentication-information management unit associating and managing the user information inputted by the user, requesting-device identification information to identify a requesting service-provision unit sending the authentication request to the authentication control unit, and requested-device identification information to identify uniquely the one of the authentication devices to which the authentication control unit transmits the request for performing the authentication processing.

In the above-mentioned information-processing device, the user information, such as the user name, the password, etc. which has been inputted by the user can be retained, and, even when the user's authentication is needed again, it is possible that the above-mentioned information-processing device requests the user's authentication to the authentication device using the currently retained user information, without requesting the user to input the user information again.

Alternatively, the above-mentioned objects of the present invention may also be achieved by an information-processing method for the above-mentioned information-processing device, an information-processing system including the above-mentioned information-processing device, an information-processing program for causing the information-processing device to perform the information-processing method, or a recording medium which storing the information-processing program.

According to the present invention, it is possible to provide the information-processing device, the information-processing system, the information-processing method, the information-processing program and the recording medium which enable the user to use the services of the plurality of external devices only with the input operation of user information which is performed once.

### BRIEF DESCRIPTION OF THE DRAWINGS

Other objects, features and advantages of the present invention will be apparent from the following detailed description when reading in conjunction with the accompanying drawings.

FIG. 1 is a block diagram showing the composition of a network system in which the authentication function is implemented in one server collectively.

FIG. 2 is a block diagram showing the composition of the document-management system in the first preferred embodiment.

FIG. 3 is a block diagram showing the hardware composition of the client device in the preferred embodiment of the invention.

FIG. 4 is a block diagram showing the functional composition of the client device in the preferred embodiment of the invention.

FIG. 5 is a diagram showing an example of the main screen of the client application on the display device.

FIG. 6 is a sequence diagram for explaining the authentication processing when the authentication service does not receive authentication.

FIG. 7 is a sequence diagram for explaining the authentication processing when the authentication service does not receive authentication.

FIG. 8 is a diagram showing the composition of the authentication information table.

FIG. 9 is a block diagram for explaining the relation between the entry and the instance.

FIG. 10 is a sequence diagram for explaining the authentication processing in the first preferred embodiment after authentication is received at least once.

FIG. 11 is a sequence diagram for explaining the authentication processing in the first preferred embodiment after authentication is received at least once.

FIG. 12 is a block diagram showing the composition of the document-management system in the second preferred embodiment.

FIG. 13 is a block diagram showing the conceptual composition of the document-management system in the second preferred embodiment.

FIG. 14 is a diagram showing the example of the entries registered in the authentication information table at the time of start of the processing in the second preferred embodiment.

FIG. 15 is a sequence diagram for explaining the authentication processing in the second preferred embodiment after authentication is received at least once.

FIG. 16 is a sequence diagram for explaining the authentication processing in the second preferred embodiment after authentication is received at least once.

FIG. 17 is a diagram showing the example of the authentication information table to which a new entry is added.

FIG. 18 is a flowchart for explaining the processing performed by the authentication control module in response to the authentication request from the application.

FIG. 19 is a diagram showing the composition of the document-management system which is constituted using the image forming apparatus.

### DETAILED DESCRIPTION OF PREFERRED EMBODIMENTS

A description will now be given of the preferred embodiments of the invention with reference to the accompanying drawings.

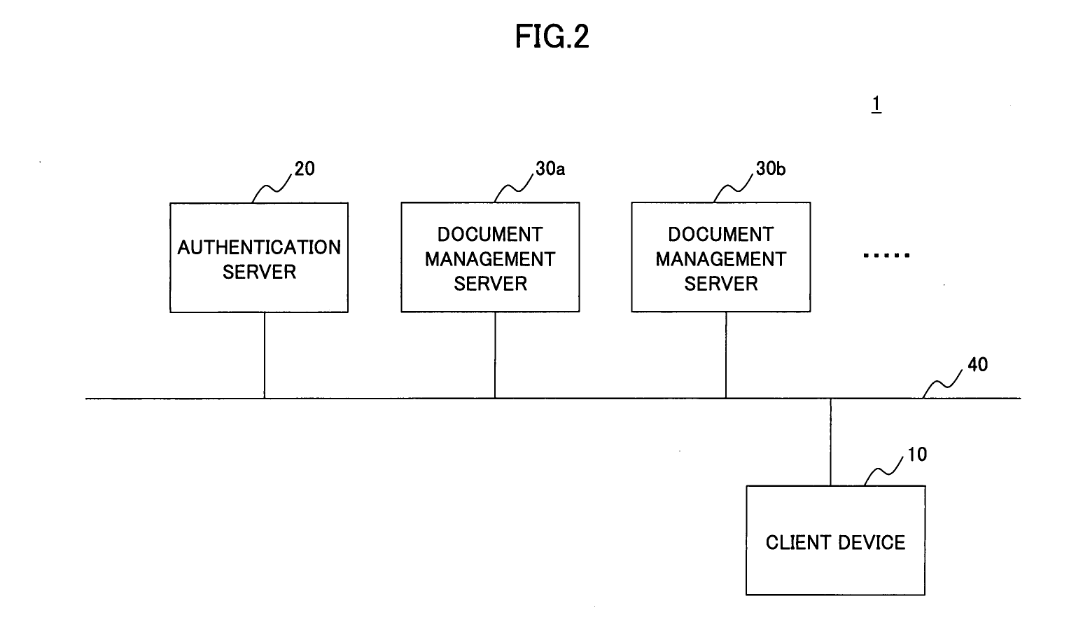

FIG. 2 shows the composition of the document-management system in the first preferred embodiment. The document-management system 1 in this embodiment generally comprises the client device 10, the authentication server 20, and the document-management servers 30a and 30b (which are collectively called the document-management server 30), which are interconnected through the network 40, such as LAN or the Internet, (which may be a wired or wireless network).

The client device 10 is the terminal, such as PC (personal computer), PDA (personal digital (data) assistant) or a cellular phone, in which various applications directly used by the user of the document-management system 1 are implemented,

The authentication server 20 is a computer in which the user's authentication function is implemented, and this authentication server 20 provides the authentication function for any device on the network 40.

The document-management server 30 is a computer in which the management function (document-information management function) of document information (the actual data of documents, bibliographic information of documents, etc.) is implemented, and this document-management server 30 provides the document-information management function for any device on the network 40. However, the document-management server 30 provides the document-information management function only to the client authenticated by the authentication function of the authentication server 20.

Therefore, the various applications of the client device 10 to which the retrieval of the document information from the document-management server 30 or the like is instructed by the user must receive authentication of the user concerned by the authentication server 20, before accessing the document-management server 30.

In the composition of FIG. 2, only the two document-management servers 30 are illustrated. The present invention is not limited to this embodiment. Alternatively, three or more document-management servers 30 may be connected onto the network 40. Moreover, a plurality of the client devices 10 or a plurality of the authentication servers 20 may be connected onto the network 40.

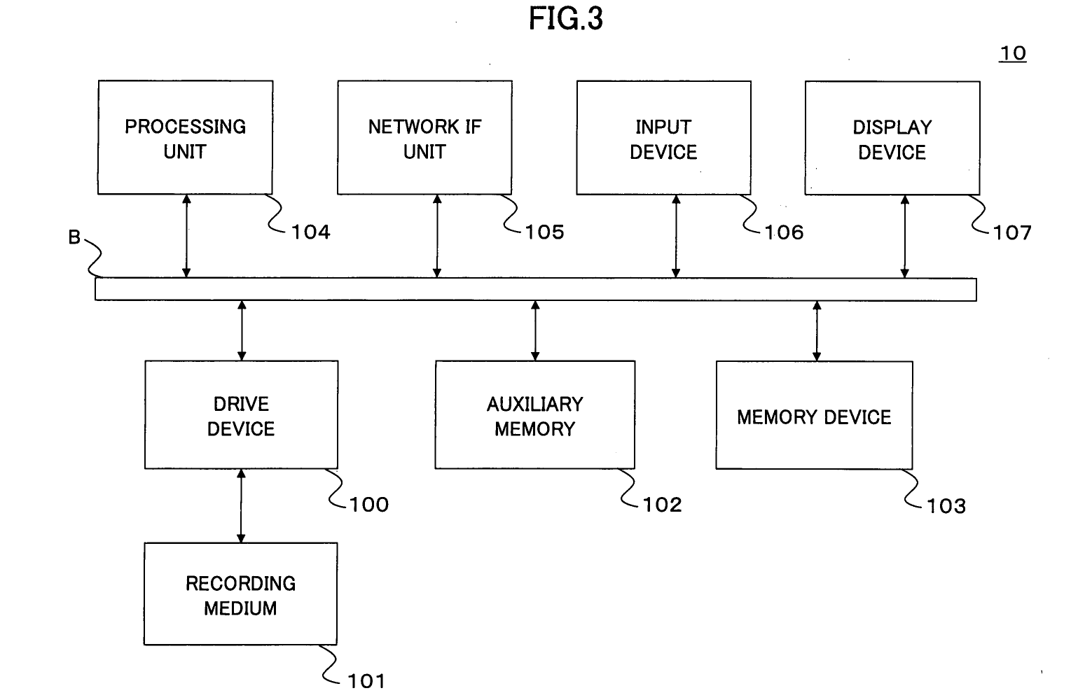

Next, the details of the client device 10 will be explained. FIG. 3 shows the hardware composition of the client device in the preferred embodiment of the invention.

The client device 10 of FIG. 3 is constituted so that it comprises the drive device 100, the auxiliary memory 102, the memory device 103, the processing unit 104, the network I/F (interface) device 105, the input device 106, and the display device 107, which are interconnected by the bus B.

The program which realizes processing being performed on the client device 10 is provided by the recording medium 101, such as CD-ROM. When the recording medium 101 which stores the program is set in the drive device 100, the program read from the recording medium 101 is installed in the auxiliary memory 102 through the drive device 100. The auxiliary memory 102 stores the necessary files, the necessary data, etc. in addition to the installed program.

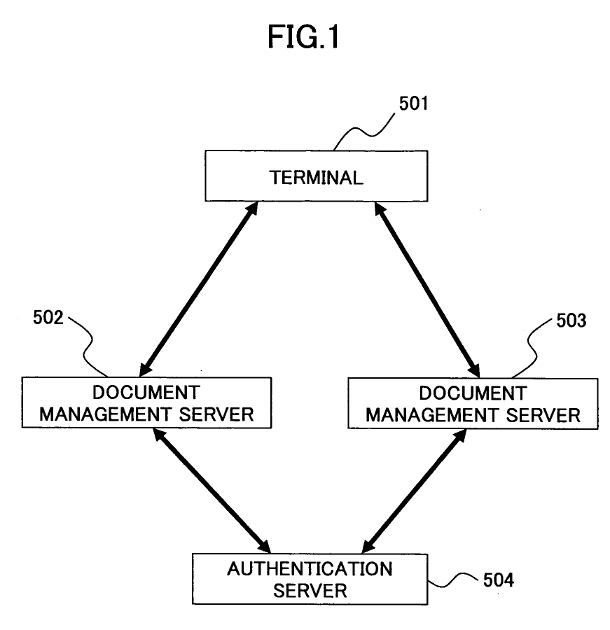

When a command to start execution of the program is received, the program is read from the auxiliary memory 102 and stored into the memory device 103. The processing unit 104 carries out the functions related to the client device 10 according to the program stored in the memory device 103. The network I/F device 105 comprises the modem, the router, etc., and it is used in order to connect the client device 10 to the network 30 of FIG. 1.

The input device 106 comprises the keyboard, the mouse, etc., and it is used in order to input various kinds of operational information. The display device 107 displays the GUI (graphical user interface) according to the program etc.

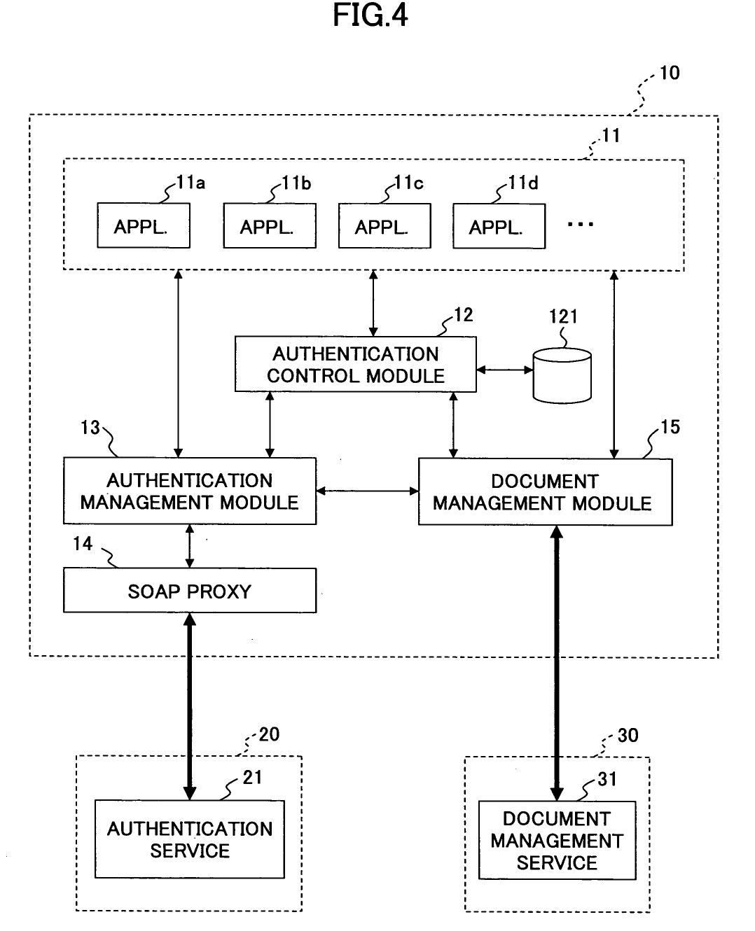

Next, the functional composition of the document-management system 1 will be explained. FIG. 4 shows the functional composition of the client device in the preferred embodiment of the invention.

As shown in FIG. 4, the client device 10 comprises the client application 11, the authentication control module 12, the authentication management module 13, the SOAP proxy 14, and the document-management module 15.

The client application 11 provides the integrated environment (user interface) in which the plurality of plug-in applications, such as application 11a, application 11b, application 11c and application 11d, are integrated. That is, the client application 11 is capable of adding or deleting any of the plurality of plug-in applications, such as application 11a, if needed.

In addition, as the unit of processes, the client application 11 containing application 11a and others may be considered one process, and each of the respective applications, such as application 11a, may be considered as one process respectively.

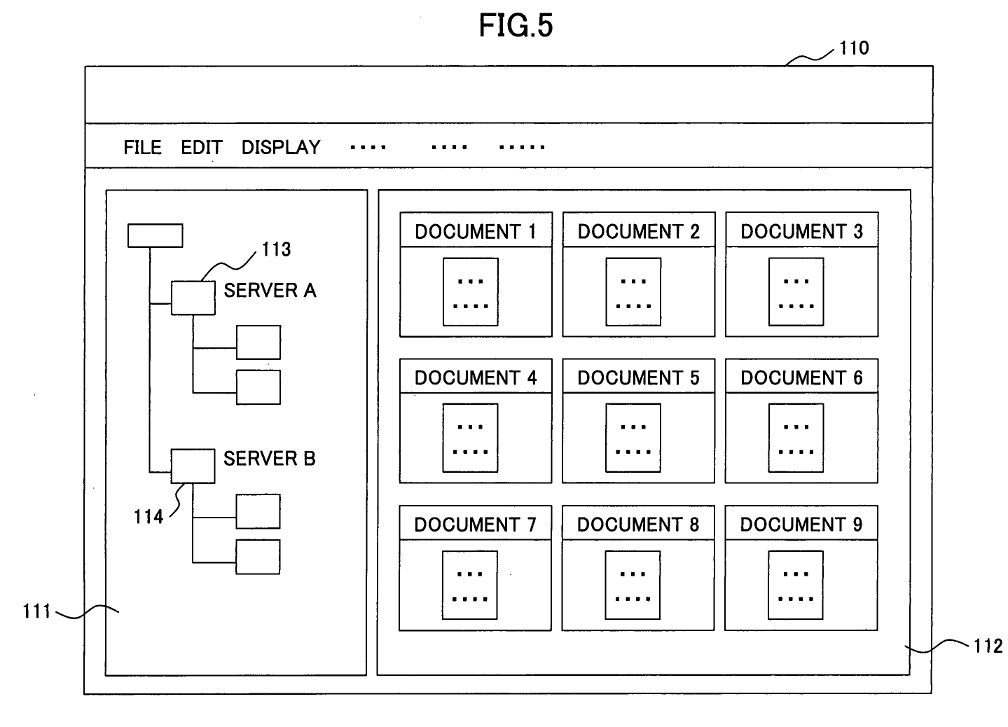

FIG. 5 shows the example of the main screen of the client application on the display device. As shown in FIG. 5, the main screen 110 comprises the tree viewing area 111 and the document list viewing area 112, which is similar to the general-purpose document-management application. The storing location of document information is displayed on the tree viewing area 111 as a node in the tree form.

The node 113 in the tree viewing area 111 is the node corresponding to the document-management service 31 (called “document-management service 31a”) of document-management server 30a, and this node corresponds to one application (in this case, application 11a). Namely, if the user clicks the node 113, the application 11a is called, and the document information stored in document-management service 31a is displayed in the document list viewing area 112 by the processing which is performed by the application 11a.

Similarly, the node 114 in the tree viewing area 111 is the node corresponding to the document-management service 31 (henceforth “document-management service 31b”) of document-management server 30b, and this node corresponds to the application 11b. Therefore, with the application 11a and the application 11b, the user is provided with the interfaces to document-management server 30a and document-management server 30b.

On the other hand, the list of the icons (document icon) of the document information stored in the node (folder) chosen in the tree viewing area 111 is displayed in the document list viewing area 112 in the thumbnail form. By operating the document icon displayed in the document list viewing area 112, the user can delete the document information concerned, or can copy or move it to another folder.

Referring back to FIG. 4, the authentication control module 12 is the module which receives the authentication request from application 11a etc., and controls the processing performed based on the authentication request concerned. The authentication control module 12 has the authentication information table 121, and controls the processing based on the authentication information table 121.

The authentication management module 13 is the module which transmits the request of authentication etc. to the authentication server 20 in response to the request from the authentication control module 12. The authentication management module 13 transmits the request to the authentication server 20 through the SOAP proxy 14.

The SOAP proxy 14 is the module for providing the interface to the authentication service 21 (mentioned later) in the authentication server 20 in a manner that is transparent to the high-order module (in this example, the authentication management module 13). That is, the SOAP proxy 14 converts the request according to the interface called from the high-order module into the SOAP message, and transmits the SOAP message to the authentication service 21. Moreover, the SOAP proxy 14 receives the information included in the SOAP message answered from the authentication service 21, and sends the corresponding information to the high-order module.

The document-management module 15 is the module in which the various interfaces for using the document-management service 31 (mentioned later) in the document-management server 30 are implemented. The document-management module 15 transmits the request according to the interface called from the high-order module (such as application 11a etc.) to the document-management service 31, and sends the information answered from the document-management service 31 in response to the request, to the high-order module.

The authentication service 21 is implemented in the authentication server 20. The authentication service 21 is the module group for providing the user's authentication function as Web service. The authentication service 21 is capable of receiving the request from the client (in this example, the client device 10) by utilizing the SOAP (simple object access protocol) interface.

Moreover, the document-management service 31 is implemented in the document-management server 30. The document-management service 31 is the module group for providing the document-information management function as Web service. The document-management service 31 is capable of receiving the request from the client (in this example, the client device 10) by utilizing the SOAP interface.

In addition, it is illustrated in FIG. 4 that the client application 11 and the authentication control module 12 have the relation of the one-to-one correspondence, and the authentication control module 12 is used in common by the plurality of applications in the client application 11 (such as application 11a etc.). The present invention is not limited to this composition. Alternatively, the client device 10 may be configured so that the authentication control module 12 is shared by not only the applications in the client application 11 but also the applications which are completely independent from the client application 11.

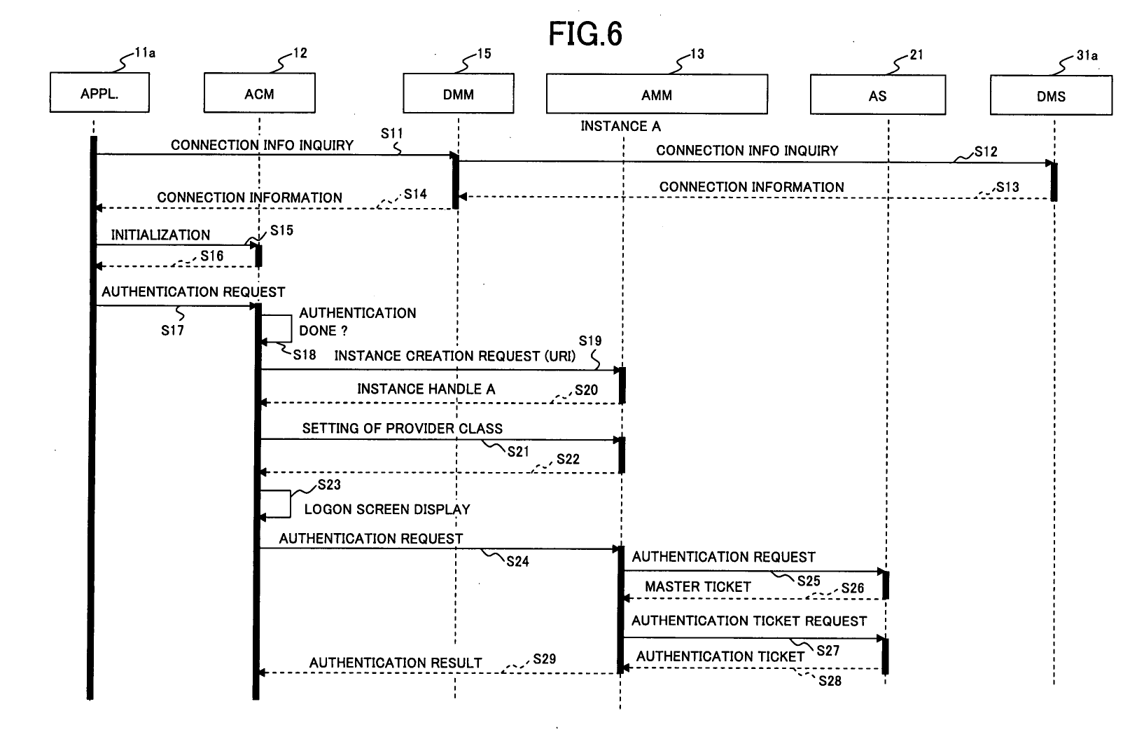

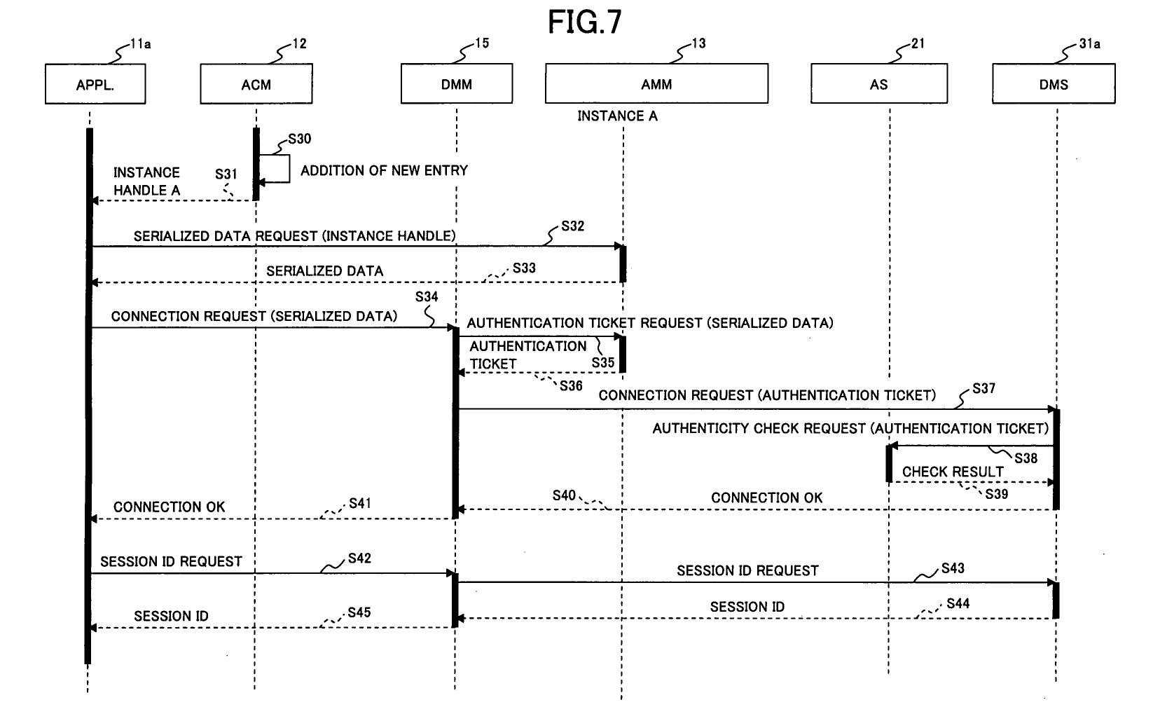

Next, the processing procedure of the document-management system of FIG. 2 and FIG. 4 will be explained. FIG. 6 and FIG. 7 are the sequence diagrams for explaining the authentication processing when the authentication service 21 does not receive authentication.

Suppose that, in the initial state of FIG. 6, execution of the client application 11 has been just started. Therefore, the nodes 113 and 114 in the main screen 111 are in the closed state, and none of the document icons is displayed in the document list viewing area 112. The processing will be started if the user clicks the node 113 to access the document-management service 31a.

In step S11, the application 11a transmits, in response to the click of the node 113 by the user, the inquiry of the information needed to access the document-management service 31a (which information indicates which of the authentication services has to be used to authenticate the user in order to access the document-management service 31a, or the like), to the document-management module 15. Such information will be called the connection information.

Progressing to step S12 following step S11, the document-management module 15 requests the connection information to the document-management service 31a. In step S13, the connection information is sent from the document-management service 31a back to the document-mamagement module 15. In step S14, the connection information is notified to the application 11a.

The connection information acquired includes the classification of the authentication provider, the domain name of the domain where the user receives authentication, the URI of the authentication service 21 as URI of the authentication service by which the user receives authentication, etc.

The authentication provider will now be explained. The authentication service 21 in the present embodiment can be dealt with various authentication engines, such as the network authentication of Windows (registered trademark) or the authentication engine developed by the user uniquely.

However, in order to conform with each authentication engine, it is necessary to implement for every authentication engne the module which absorbs the original interface contained in the authentication engine, and provides the unified interface which is beforehand defined to the high-order module. The module for providing the unified interface is called the authentication provider.

Moreover, the classification of the authentication provider (called “provider classification”) is the identification information for identifying each authentication provider. It corresponds to, for example, the name which is assigned for each authentication provider.

Therefore, based on the URI and provider classification of the authentication service 21 contained in the received connection information, the application 11a can determine with which authentication service and by which authentication provider the user has to be authenticated in order to access the document-management service 31a.

In addition, the concept of provider classification is introduced in this embodiment in consideration of the case where one or more authentication providers are implemented in the single authentication service 21. However, in the case where only one authentication engine is implemented in the authentication service 21, the authentication service 21 is determined uniquely, and the authentication engine is determined uniquely. In such a case, it does not need to determine the authentication engine using the concept of provider classification.

In step S14, the application 11a initializes the authentication control module 12 in preparation for receiving authentication in the authentication service 21 (S15, S16).

Progressing to step S17 following step S16, the application 11a specifies the instance handle, the URI of the authentication service 21, the domain name, the provider classification, etc. to be the arguments, and sends the request to the authentication control module 12, so that the authentication service 21 should perform the user's authentication.

In this case, the instance handle (which will be mentioned later) is the information returned from the authentication control module 12 as a return value to the authentication request concerned, and the authentication control module 12 mainly uses this instance handle as the information (requesting-device identification information) for identifying each application. Therefore, when the authentication request is performed for the first time, the instance handle is not published, and the null value (NULL) is specified to be the argument.

Progressing to step S18 following step S17, the authentication control module 12 determines whether the authentication by the authentication service 21 is already performed. The details of this determination processing will be mentioned later.

The processing in this embodment is the processing when the user does not receive authentication yet, and the authentication control module 12 determines that the authentication is not performed, and starts the processing for receiving authentication.

Progressing to step S19 following step S18, the authentication control module 12 requests the creation of the instance by setting the URI of the authentication service 21 into the argument, to the authentication management module 13.

The instance in this case is the concept of the management unit assigned to each connection in the authentication management module 13, in order to identify each of the respective connections between the applications (application 11a etc.) and the document-management services 31.

In the present embodiment, each application and each document-management service have the relation of 1 to 1, and one instance is substantially managed on the basis of every application. And the information for identifying this instance uniquely is the instance handle. In addition, as substance on the implementation of the instance, the instance may be set as the object, the structure, or the record in the table, etc.

The authentication management module 13 creates the instance in response to the request from the authentication control module 12, and sets the URI of the authentication service 21 to the created instance. In addition, the instance created here will be called “instance A” below.

Progressing to step S20 following step S19, the authentication management module 13 returns the instance handle (called “instance handle A”) of instance A to the authentication control module 12. The instance handle returned here is used in order that the authentication control module 12 may identify each application.

Progressing to step S21 following step S20, the authentication control module 12 sets into the argument the instance handle A of instance A and the provider classification, and requests the authentication management module 13 so that they are set to the instance A of the provider classification of the authentication provider which is the authentication location. The authentication management module 13 sets the provider classification to the instance A, and notifies the result to the authentication control module 12 (S22).

Progressing to step S23 following step S22, the authentication control module 12 displays the logon screen for making the user input the user information, such as the user name and the password. If the user inputs the user name and password with respect to the authentication service 21 into the logon screen, the authentication control module 12 requests authentication to the authentication management module 13 by setting into the argument the instance handle A, the user name and password inputted into the logon screen, the domain name, and the term of validity of authentication (S24).

Progressing to step S25 following step S24, the authentication management module 13 requests authentication to the authentication service 21 which is identified by the URI set to instance A. In addition, the user name, the password, the domain name, the provider classification, the term of validity, etc. are specified as the argument for the request of authentication to the authentication service 21. The provider classification is already set to instance A.

Progressing to step S26 following step S25, the authentication service 21 authenticates the user based on the user name and the password using the authentication provider identified by the provider classification specified in the argument. When the user is authenticated, the authentication service 21 creates the data (henceforth the “ticket”) as a certificate in which the result that the user was authenticated is shown, and answers the authentication management module 13 by sending the created ticket (S26). In addition, the term of validity specified in the argument is recorded in the created ticket.

The ticket will now be explained. In the present embodiment, the two kinds of ticket: the master ticket and the authentication ticket are defined. Although each ticket is common in the point of serving as a certificate that the user was authenticated, the master ticket and the authentication ticket differ in the usage greatly.

The authentication ticket is the ticket that is effective only in the limited range. For example, the authentication ticket published for the document-management server 30a cannot be used for the document-management server 30b. This is because other servers do not accept the request accompanied by the authentication ticket published for the specific server other than themselves.

On the other hand, the master ticket is the all-round ticket that is effective in all the server devices conforming to the authentication using the ticket. Moreover, issue of the authentication ticket can be accepted by presenting the master ticket.

The reason the two kinds of ticket are defined mainly depends on the viewpoint of the security. That is, the authentication ticket is the ticket which is defined in order not to circulate the master ticket frequently on the network. Therefore, the master ticket is used only on the restricted occasions, such as the issue of the authentication ticket being requested.

In addition, the ticket which is creates in step S25 is the master ticket. Therefore, in step S26, the master ticket is transmitted to the authentication management module 13.

Progressing to step S27 following step S26, the authentication management module 13 requests issue of the authentication ticket by setting the master ticket into the argument, to the authentication service 21.

Progressing to step S28 following step S27, the authentication service 21 checks the justification of the master ticket, such as the term of validity, etc., and publishes the authentication ticket to the authentication management module 13 when the justification is approved. The authentication management module 13 assocaites with instance A the authentication ticket received from the authentication service 21, and stores the association therein.

Progressing to step S29 following step S28, the authentication management module 13 returns the authentication result (in this case, that the user is authenticated) to the authentication control module 12 as a response to the authentication request (S24).

Progressing to step S30 (FIG. 7) following step S29, the authentication control module 12 adds the new entry to the authentication information table 121 based on the result that the authentication has been successful.

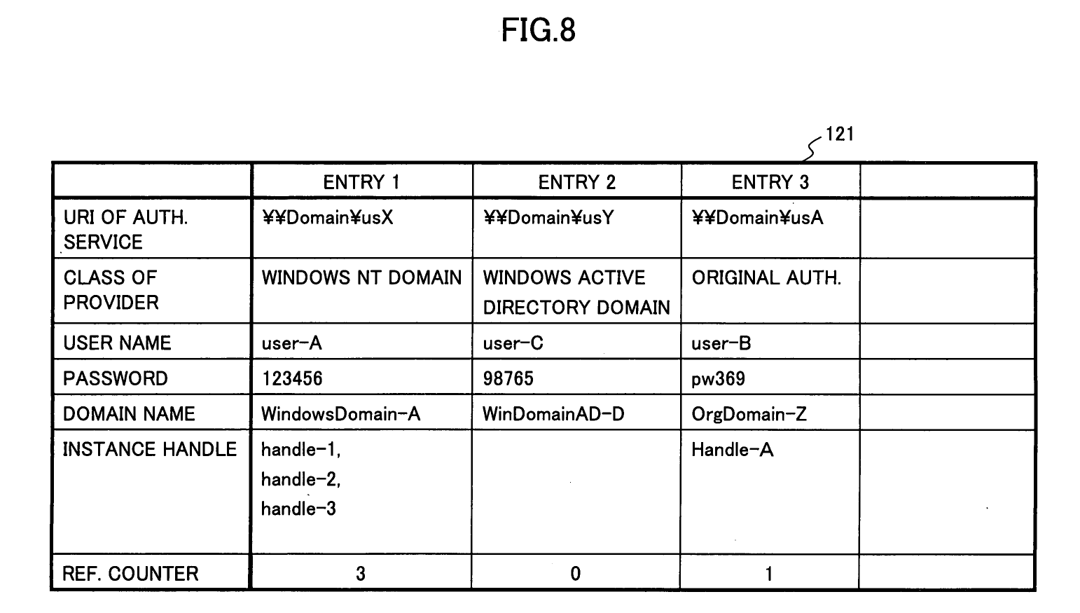

FIG. 8 shows the composition of the authentication information table. As shown in FIG. 8, the authentication information table 121 is the table which is provided for managing the information about the authentication location when authentication is successful, and the user information used on that occasion (called “authentication information”). The authentication information table 121 contains the various items, such as the URI (requested-device identification information) of the authentication service, the provider classification, the user name, the password, the domain name, the instance handle (requesting-device identification information), and the reference counter.

The authentication information table 121 is used to manage the authentication information for every entry which is determined uniquely by the URI of the authentication service and the provider classification. In the present embodiment, it is supposed that one client device 10 is used by one user. Namely, the relation that the number of user information (the user name and password) is one for every authentication location is supposed.

Therefore, each entry does not need to take user information into consideration, and becomes settled uniquely, URI and provider classification, i.e., the authentication location, of the authentication service. However, if authentication locations differ even if it is the same user, user information may also differ. This is because the user may register a different account for every authentication location. Hence, the user name and password for each entry may differ.

In the authentication information table 121, if it is the instance (which is managed by the authentication management module 13) with the same authentication location, it is managed in the same entry, although the document-management services 31 differ.

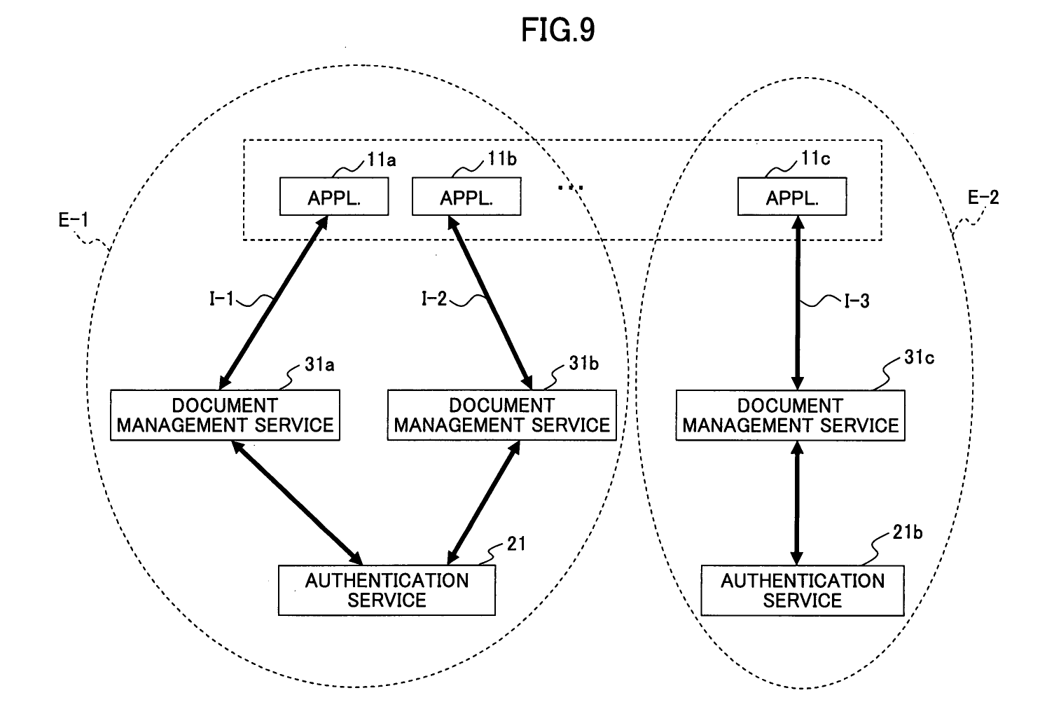

FIG. 9 is a diagram for explaining the relation between the entry and the instance. The following are shown in FIG. 9.

Suppose that the application 11a accesses the document-management service 31a, the application 11b accesses the document-management service 31b, and both the document-management service 31a and the document-management service 31b use the authentication service 21 as the common authentication location.

Furthermore, suppose that the application 11c accesses the document-management service 31c, and the document-management service 31c uses the authentication service 21b as the authentication location.

In FIG. 9, the respective connections between the applications and the document-management services, indicated by the reference numeral I-1, I-2, and I-3, correspond to the instances respectively. In this case, assuming that the user of application 11a, application 11b, and application 11c is the same person, the instance I-1 and the instance I-2 have the authentication location as the same authentication service 21, and they belongs to the same entry (entry E-1 in FIG. 9).

On the other hand, the instance I-3 belongs to the different entry (entry E-2 in FIG. 9) because it has the authentication location which is different from that of the instance I-1 and the instance I-2.

In the table of FIG. 8, the plurality of instance handles are registered into the entry 1. This means that the plurality of instances having the same authentication location belong to the entry 1. The value of the reference counter indicates the number of the instances within one entry.

In addition, the entry which is newly added in step S30 corresponds to the entry 3 in FIG. 8. That is, the URI of the authentication service is “¥¥Domain¥usA” and the provider classification is “original authentication”.

Progressing to step S31 following step S30, the authentication control module 12 returns the instance handle A to the application 11a as the response to the authentication request from the application 11a (S17). Namely, the application 11a only receives the instance handle A as a return value to the authentication request, without being subjected to determination of the necessity of the input of the user information by the user etc., after performing the authentication request (S17) to the authentication control module 12.

Progressing to step S32 following step S31, the application 11a requests receiving of the data (henceforth “serialized data”) which is created by serializing the authentication ticket, to the authentication management module 13, by setting the instance handle A into the argument. The authentication management module 13 creates the serialized data by serializing the authentication ticket associated with instance A, and returns the serialized data to the application 11a (S33). This means that the application 11a has acquired the information (the serialized data of the authentication ticket) proving the result that the user is authenticated by the authentication service 21. Then, the application 11a starts accessing the document-management service 31a anew.

Progressing to step S34 following step S33, the application 11a requests connection with the document-management service 31a by setting the serialized data into the argument, to the document-management module 15.

Progressing to step S35 following step S34, the document-management module 15 requests receiving of the authentication ticket by setting the serialized data into the argument, to the authentication management module 13. The authentication management module 13 returns the corresponding authentication ticket to the document-management module 15 (S36).

Progressing to step S37 following step S36, the document-management module 15 requests connection to the document-management service 31a by setting the authentication ticket into the argument. The document-management service 31a requests the check of the justification of the authentication ticket to the authentication service 21 (S38). Then, the authentication service 21 checks the justification of the authentication ticket, such as the term of validity of the authentication ticket etc., and transmits the result of the checking to the document-management service 31a (S39).

Progressing to step S40 following step S39, when the justification of the authentication ticket is approved, the document-management service 31a transmits the result that the connection is permitted, to the document-management module 15. The document-management module 15 returns to the application 11a the result that the connection is permitted (S41).

Progressing to step S42 following step S41, the application 11a requests receiving of session ID to the document-management service 31a through the document-management module 15 (S43). The session is established by the document-management service 21, and the document-management service 21 sends the session ID to the application 11a (S44, S45).

In the above case, the application 11a is then capable of receiving various services (retrieval of document information etc.) of the document-management service 31a during the established session.

In the above processing, the user has been authenticated by the authentication service 21. Moreover, the authentication information at the time of the user receiving authentication by the authentication service 21 is registered into the authentication information table 121 as an entry. In such a case, suppose that the user is going to use, for example, the application 1b. Next, the processing at the time of accessing the document-management service 31b in the document-management server 30b different from the document-management service 31a will be explained below.

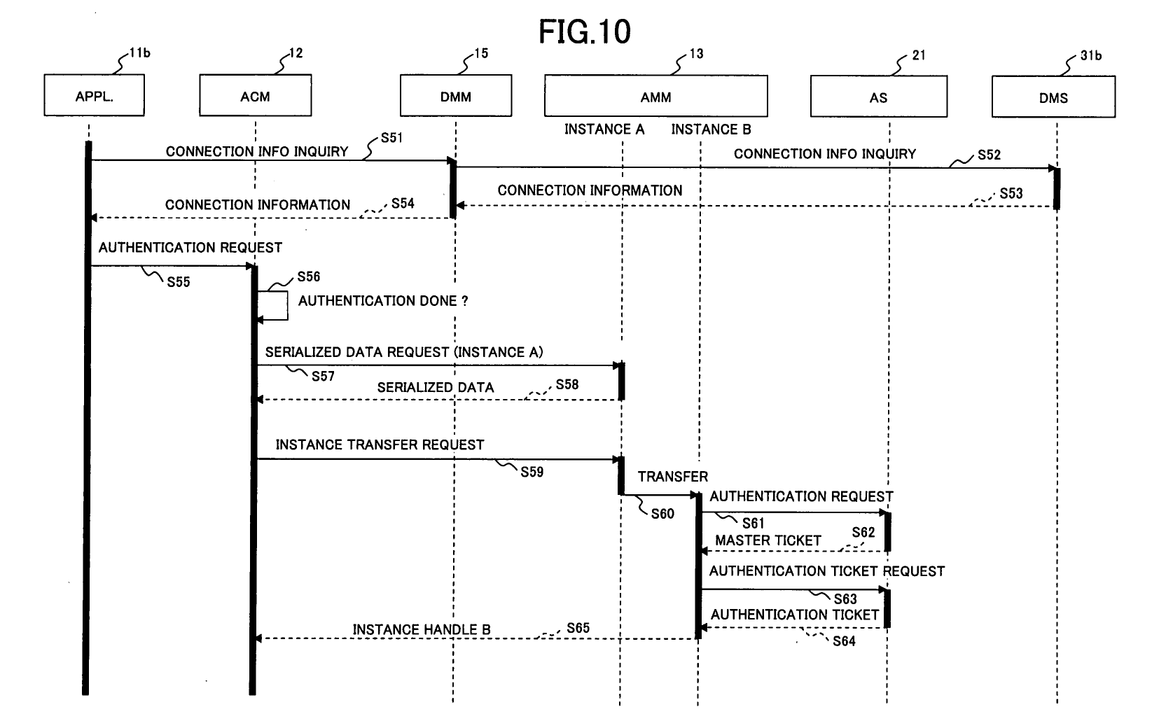

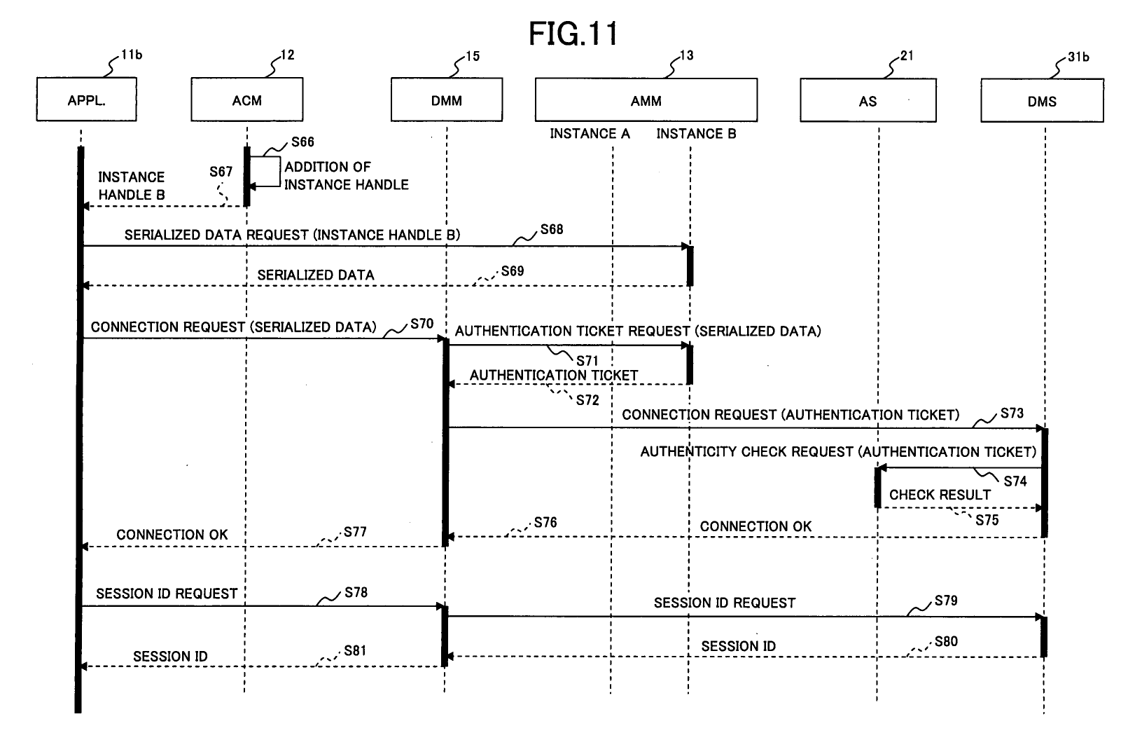

FIG. 10 and FIG. 11 are the sequence diagrams for explaining the authentication processing in the first preferred embodiment after authentication is received at least once.

Processing will be started if the user clicks the node 114 of the main screen 110 (FIG. 5) that document-management service 31b should be accessed. The application—it is the same as that of (S51-S54), and the case (S11-S14) where-it mentions above that 11b acquires connection information from document-management service 31b based on the click of the node 114 by the user.

In addition, the classification of the domain and authentication provider who receive URI of the authentication service which should receive the authentication included in the connection information acquired here, and authentication etc. presupposes that it was the same value as the thing in the connection information in the case of accessing document-management service 21a mentioned above.

That is, in the first preferred embodiment, in order to access document-management service 21b, suppose that it needs to be authenticated by the same authentication service as the case where document-management service 21a is accessed (authentication service 21), and the same authentication provider (original authentication). management service 21a is accessed.

Progressing to step S55 following step S54, the application 11b specifies the instance handle (NULL value), the URI of the authentication service 21, the domain name, the provider classification, etc. to be the arguments, and sends the request to the authentication control module 12, so that the authentication service 21 should perform the user's authentication.

In addition, in the case where it is not the application 11b but the application 11a which performs the authentication request here, the instance handle A already published to the application 11a is specified as the instance handle in the argument.

Progressing to step S56 following step S55, the authentication control module 12 determines whether authentication by the authentication service 21 is already performed for the application of authentication request source with reference to the authentication information table 121.

As mentioned above, when authentication is received, the authentication information in that case is added to the authentication information table 121 as an entry. Therefore, it can be determined that the authentication by the authentication service 21 is already performed for the application of authentication request source, if the authentication information table 121 contains the registered entry with the instance handle, the authentication service URI, and the provider classification, which are the same as the instance handle, the authentication service URI, and the provider classification specified as the argument of the authentication request of step S55.

Therefore, if the authentication request source should be the application 11a, the authentication control module 12 determines that the authentication is already performed for the application 11a, by detecting the entry 3 in the table. Then, the processing progresses to step S67 without performing the subsequent steps S57 to step S66, the authentication control module 12 will return the instance handle A, which is contained in the entry 3, to the application 11a as a response to the authentication request.

However, the authentication request source in this example is the application 11b which does not receive authentication yet, and the entry corresponding to the application 11b does not exist in the table 121. For this reason, the authentication control module 12 performs the subsequent step S57 in order to perform the authentication for the application 11b also.

However, the authentication location (authentication service and authentication provider) specified in the authentication request from the application 11b is the same as the authentication location at the time of performing the previous authentication for the application 11a. It is expected that, if the input of the user information is requested by displaying the login screen, the inputted user information is the same as the user information inputted into the logon screen at the time of using the application 11a. Then, according to the present embodiment, the authentication control module 12 reuses the user information inputted at the time of using the application 11a, and performs the subsequent steps such that the burden on the user is made as small as possible.

Progressing to step S57, the authentication control module 12 sets into the argument the instance handle A registered in the entry 3, and requests receiving of the serialized data, to the authentication management module 13. The authentication management module 13 returns the serialized data, created with respect to the instance A, to the authentication control module 12 (S58).

Progressing to step S59 following step S58, the authentication control module 12 acquires the user name, the password and the domain name, registered in the entry 3, and specifies to be the argument the acquired data and the serialized data which is received at step S58. Then, the authentication control module 12 requests transferring of the instance A, to the authentication management module 13. In this case, the transferring of the instance means creating a new instance by transferring the attributes of the existing instance to the new instance.

Progressing to step S60 following step S59, the authentication management module 13 creates instance B as a new instance to which the attributes of instance A are transferred. For example, when the instance is implemented as an object or a structure, the transferring of the instance may be attained by implementing as a copy of the object or the structure. Moreover, when the instance is implemented as a record in a table, the transferring of the instance may be attained by implamenting as a copy of the record in the table concerned.

In steps S61-S64 following step S60, the authentication management module 13 requests authentication concerning instance B, to the authentication service 21, and acquires the master ticket and the authentication ticket with respect to instance B in response to the request.

Progressing to step S65 following step S64, the authentication management module 13 returns the instance handle (called “instance handle B”) of instance B to the authentication control module 12 as a response to the transferring request (S59) of the instance.

Progressing to step S66 (FIG. 11) following step S65, the authentication control module 12 registers the instance handle B into the entry 3, and increments the reference counter of the entry 3.

Progressing to step S67 following step S66, the authentication control module 12 returns the instance handle B to the application 11b as the response to the authentication request (S55) from application 11b.

The subsequent steps S68-S81 following step S67 in FIG. 11 are the same as the steps S32-S45 in FIG. 7 described above, respectively. Namely, the application 11b receives the serialized data of the authentication ticket (S68, S69), and establishes connection between the client device 10 and the document-management service 31b based on the serialized data (S70-S81).

According to the client device 10 in the first preferred embodiment as mentioned above, the user information which is inputted at least once is held, and it is reused when authentication is needed thereafter. It is possible that the user is released from the complicated work that the input of user information is always requested when the user accesses the server.

Next, the case where the authentication servers 20 (authentication service 21) which should receive authentication in every document-management server 30 (document-management service 31) differ as a form of the second operation will be explained.

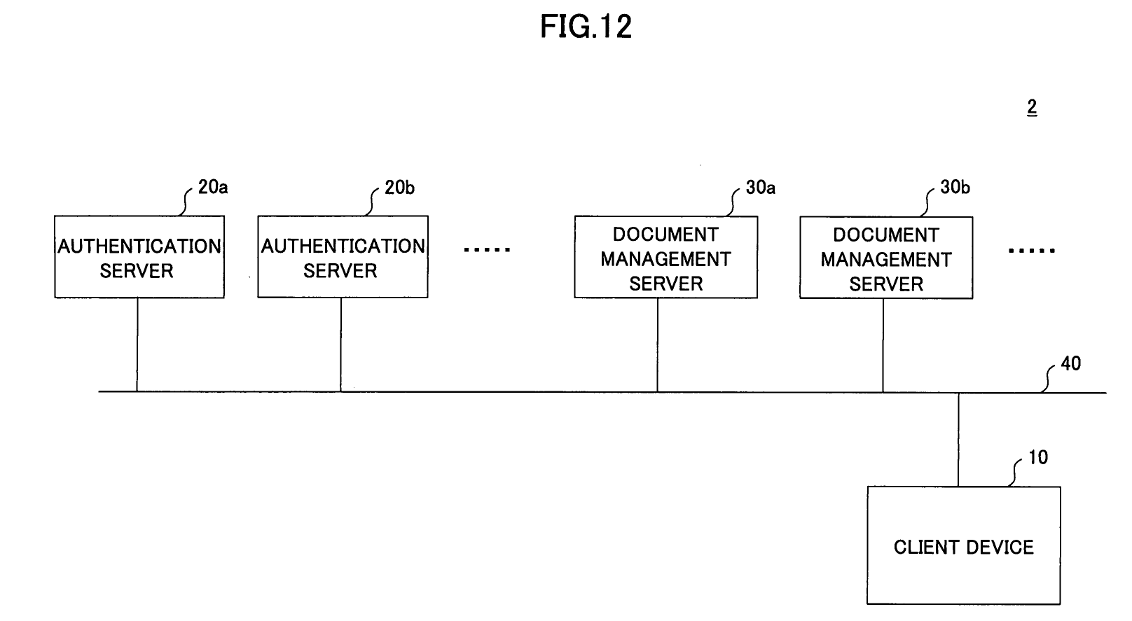

FIG. 12 shows the composition of the document-management system in the second preferred embodiment. In FIG. 12, the elements which are the same as corresponding elements in FIG. 2 are designated by the same reference numerals, and a description thereof will be omitted.

As shown in FIG. 12, the plurality of sets of the authentication servers, such as the authentication servers 20a and 20b, are connected to the document-management system 2 in the second preferred embodiment in the network 40.

The authentication server 20a is a computer in which the authentication function (authentication service 20a) of the user using document-management server 30a (document-management service 31a) is implemented.

The authentication server 20b is a computer in which the authentication function (authentication service 20b) of the user using document-management server 30b (document-management service 31b) is implemented.

In addition, although illustration is not carried out, the authentication servers (document-management services 31c and 31d etc.) 20c and 20d respectively corresponding to them, such as the document-management servers 30c and 30d, etc. shall be connected (authentication services 21c and 21d etc.).

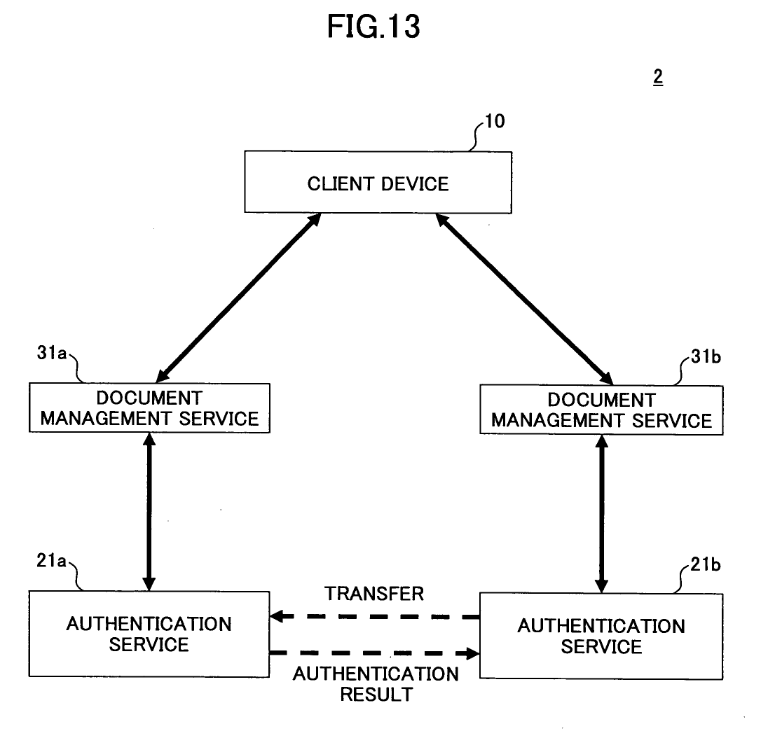

FIG. 13 is a diagram of the document-management system in the second preferred embodiment. In FIG. 13, in order for the authentication service 21a to receive authentication in order to use document-management service 31a, and to use document-management service 31b, the result which needs to receive authentication by the authentication service 21b is shown.

However, the authentication service 21b can transfer the authentication processing based on the authentication request made into oneself to the authentication service 21a. The authentication service 21a to which authentication processing was transferred authenticates based on the user information which manages oneself, and answers the authentication service 21b in the processing result.

The authentication service 21b answers authentication request source as a result of the authentication processing whose oneself performed the authentication result answered from the authentication service 21a. from the authentication service 21a, as a result of the authentication processing by itself.

In the present embodiment, the relation with which authentication processing can be transferred to is called the “confidential relation”. Therefore, it can be said that the authentication service 21a and the authentication service 21b have the confidential relation. The confidential relation is set up by specifically registering URI of the authentication service (authentication service 21a) which can be made into the transfer location of authentication processing etc. in the configuration file of the transferring agency (authentication service 21b) etc.

In addition, as for operation of the configuration file etc., to be made by the responsible users, such as the manager of the system, is desirable on the viewpoint of security.

It becomes unnecessary to overlap each authentication server 20 and to make user information manage by setting up the confidential relation between each authentication service 21.

For example, in FIG. 13, the authentication service 21a is the authentication service which manages the user information of the employee of section A, and the authentication service 21b presupposes that it is the authentication service which manages the user information of the employee of section B.

If there should be no confidential relation between the authentication service 21a and the authentication service 21b, the employee of section A cannot use the document-management service 31b.

This is because authentication will be refused as the unjust account since the user information of the employee of section A is not managed by the authentication service 21b the location which needs to be authenticated by the authentication service 21b in order to use document-management service 31b, as mentioned above.

Therefore, it is necessary to make the authentication service 31b manage the user information of the employee of section A in this case. However, if the confidential relation is set up between the authentication service 21b and the authentication service 21a, the user information on the authentication service 31b will come out as it is, and it will be said that it enables the employee of section A to use document-management service 31b it divides and comes out.

In the document-management system 2 in the second preferred embodiment, the authentication service 21a is begun and the user who already receives authentication by the authentication service 21 of those other than the authentication service 21b explains the case where it is going to use the document-management service 21 which cannot be used unless document-management service 31b, i.e., the authentication service 21b, receives authentication.

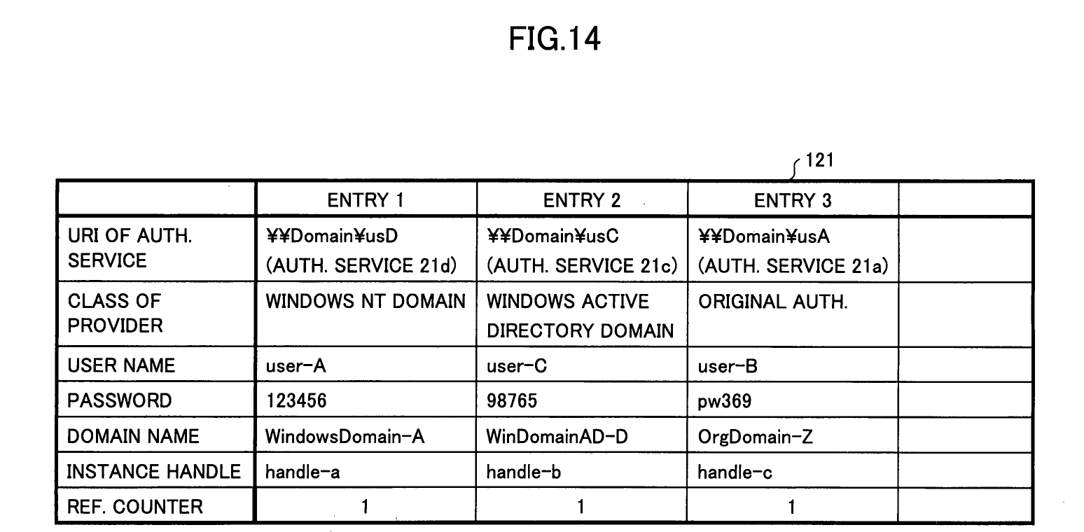

In addition, processing when it sets in the second preferred embodiment and the authentication service 21 of the deviation does not receive authentication, either is the same as the processing in the first preferred embodiment explained above with FIG. 6 and FIG. 7. Therefore, when the processing in the second preferred embodiment is started, the one or more entries are already registered into the authentication information table 121. In this example, the entries as shown in FIG. 14 will be registered.

FIG. 14 shows the example of the entry registered into the authentication information table at the time of the start of the processing in the second preferred embodiment.

In the authentication information table 121 shown in FIG. 14, the entry 1, the entry 2, and the entry 3 presuppose that it is the recording entry, when the user of the client device 10 receives authentication in the authentication service 21d and the authentication service 21c and the authentication service 21a.

Since the authentication service 21b does not receive authentication yet as mentioned above, the entry corresponding to the authentication service 21b is not registered.

Next, the procedure of the document-management system 2 in the second preferred operation is explained.

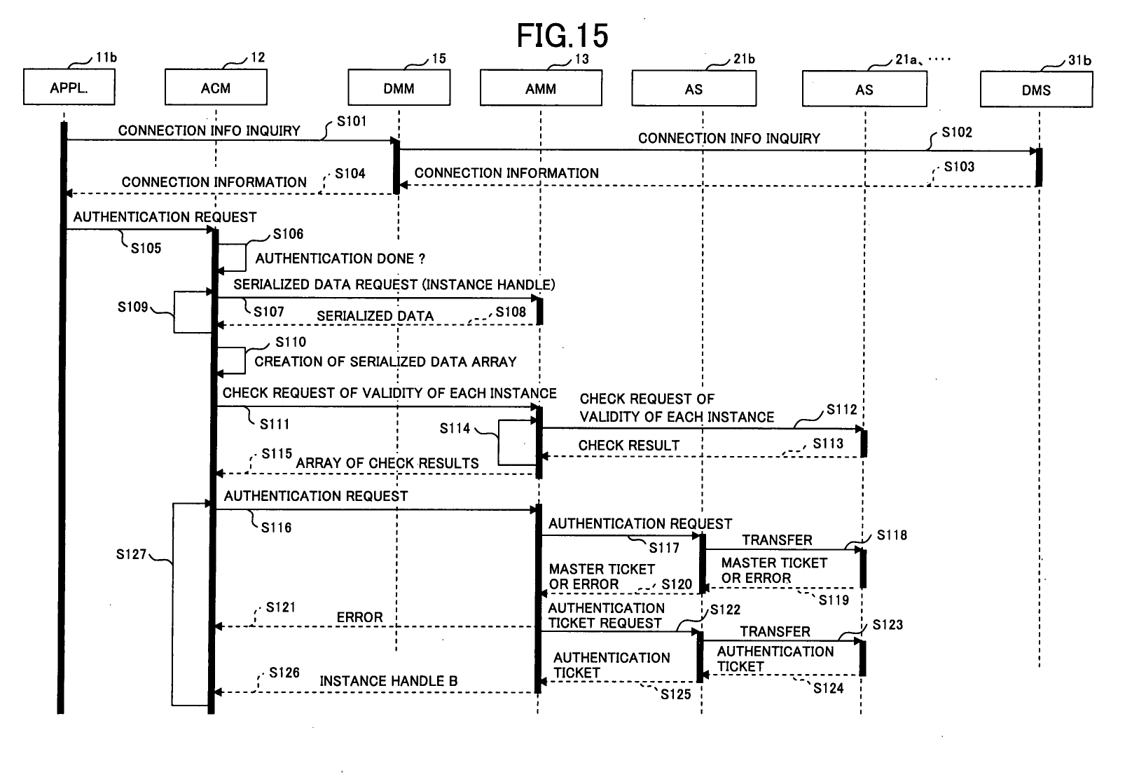

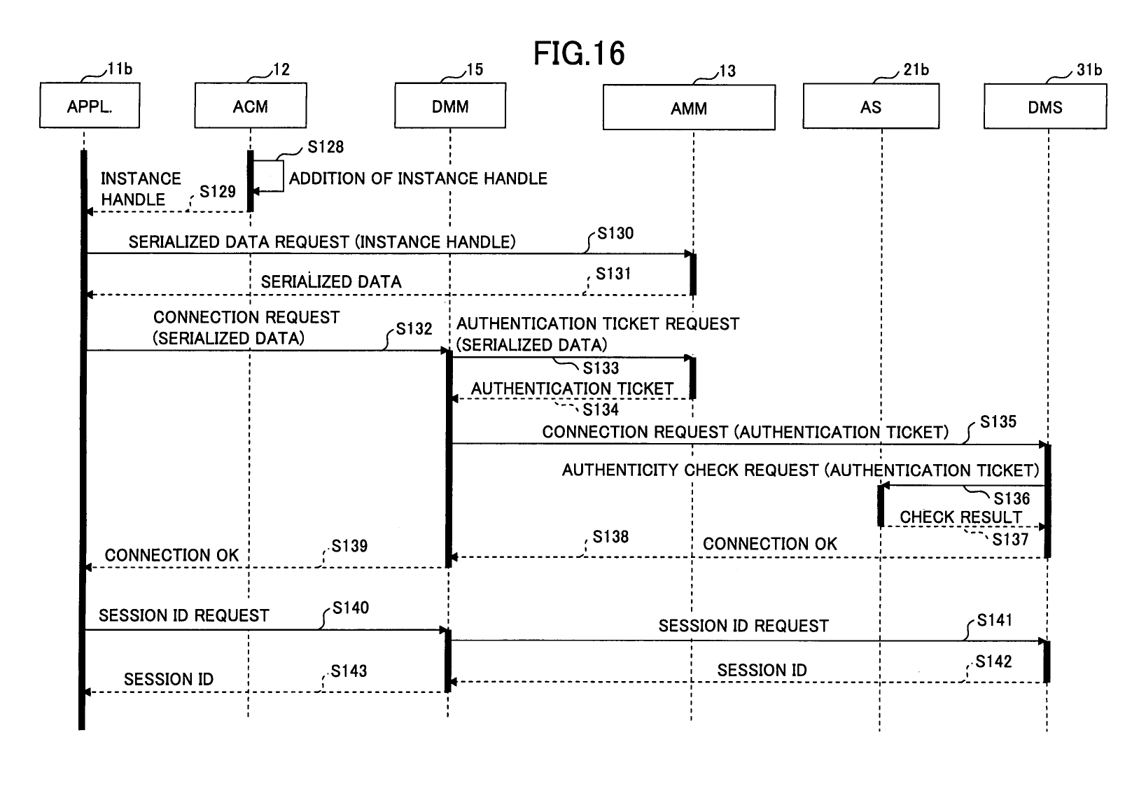

FIG. 15 and FIG. 16 are the sequence diagrams for explaining the authentication processing in the second preferred embodiment after authentication is received at least once.

The processing (S11-S104) that the application 11b acquires the connection information from the document-management service 31b based on the click of the node 114 (FIG. 5) by the user is the same as that of steps S51-S54 in FIG. 10.

However, as for URI of the authentication service which should perform authentication, URI of the authentication service 21b is specified in the acquired connection information.

In step S104 continuing step S105 progressing the application 11b requests that URI of the instance handle (NULL value) and the authentication service 21b, the domain name, provider classification, etc. should be specified to be the arguments, and the authentication service 21 should perform authentication to the authentication control module 12.

Progressing to step S106 following step S105, the authentication control module 12 determines whether authentication by the authentication service 21b is already performed with reference to the authentication information table 121 about the application of authentication request source.

Namely, the instance handle specified as an argument of the authentication request of step S105 as explained in step S56, the authentication service URI and the same instance handle as provider classification, the authentication service URI, and provider classification exist the recording entry (case 1).

Or even if instance handles differ, the recording entry exists or (case 2) the same authentication service URI and provider classification are determined.

In the case of the case 1, since it is not necessary to authenticate further, it is not necessary to request the input of user information anew of the user. Moreover, in the case of the case 2, since processing after step S57 is performed henceforth (FIG. 10 and view 11), it is not necessary to request the input of user information of the user also in this case.

However, primarily, since the entry to the authentication service 21b does not exist (FIG. 14), it corresponds to neither the case 1 nor the case 2.

However, I do not want to request the input of the user name etc. as much as possible that the burden to the user should be reduced. Then, processing for the authentication service 21b receiving authentication is performed using the user information inputted when receiving authentication in other authentication services 21 henceforth.

Progressing to step S107 following step S106, the authentication control module 12 acquires the serialized data corresponding to the instance handle concerned from the authentication management module 13 based on the instance handle belonging to each entry already registered into the authentication information table 121 (S108).

This processing is performed about all the instance handles registered into the authentication information table 121 (S109). Therefore, the serialized data corresponding to handle-a in the entry 1, handle-b in the entry 2, and handle-c in the entry 3 are acquired.

Progressing to step S110 following step S109, the authentication control module 12 creates the array which uses the acquired serialized data as the array elements (S110).

Progressing to step S111 following step S110, and the authentication control module 12 requests the check of the effectiveness of each serialized data of the authentication management module 13 by setting into the argument the URI and provider classification of the authentication service 21b in the array of serialized data, its number of the array element, and the requested-device of authentication.

Here, with the check of the effectiveness of serialized data, the check of the term of validity of the authentication ticket corresponding to the serialized data concerned etc. corresponds, for example.

Progressing to step S112 following step S11, for every serialized data, the authentication management module 13 requests the check of the effectiveness of the authentication ticket etc. from the authentication service 21 of authentication ticket corresponding to serialized data concerned issue-origin, and acquires the check result of the effectiveness of each serialized data from each authentication service 21 (S113, S114).

Progressing to step S115, the authentication management module 13 outputs the array which uses the check result of the effectiveness of each serialized data as the element to the authentication control module 12.

Progressing to step S116 following step S115, the authentication control module 12 specifies the user name of the entry to which the instance handle corresponding to the serialized data with which effectiveness was checked belongs, the password, the domain name and provider classification, and URI and provider classification of the authentication service 21b that are made into the present authentication location to be the arguments, and it is requested for the authentication management module 13 that the authentication service 21b should perform authentication.

Namely, if the authentication service 21b is in other authentication services 21 and the confidential relation being concerned others the authentication service 21b can receive authentication using the user name, password, and domain name at the time of being authenticated by the authentication service 21.

Then, trying the authentication request to the authentication service 21b using the user name and password which were inputted when the authentication control module 12 expected that it is in the authentication service 21 and the confidential relation of the others in which the authentication service 21b already received authentication and authentication was received in other authentication services 21, the domain name, etc.

Therefore, when the effectiveness of the serialized data corresponding to all the instance handles in the entries 1, 2, and 3 of FIG. 14 is checked, the authentication request using the user information in the entry 1, the user information in the entry 2, and the user information in the entry 3 is made by turn to the authentication management module 13 (S127).

Progressing to step S117 following step S116, the authentication management module 13 which received the authentication request from the authentication control module 12 specifies the user name specified to be the argument of the authentication request concerned, the password, the domain name, provider classification, etc. to be the arguments, and transmits the authentication request to the authentication service 21b.

Progressing to step S118 following step S117, the authentication service 21b transfers authentication processing to the authentication service 21a in the confidential relation.

Progressing to step S119 following step S118, the authentication service 21a authenticates based on the user name, the password, the domain name, etc., and when authenticated, it answers the authentication service 21b in the result (error) that the master ticket went wrong at authentication when authentication was refused.

Progressing to step S120 following step S119, the authentication service 21b answers the authentication management module 13 in the master ticket or error answered from the authentication service 21a.

That authentication succeeds in the authentication service 21a to which authentication processing was transferred among the authentication requests using the user information on the entry 1, the entry 2, and the entry 3 here is the authentication request which used the user information on the entry 3.

The user information on the entry 3 is because it is authenticated by the authentication service 21a in the past. Since the user information on the entry 1 and the entry 2 is not user information over the authentication service 21a, it has authentication refused by the authentication service 21a on the other hand.

The authentication management module 13 returns the error to the authentication control module 12, when a letter is answered in the error from the authentication service 21 (S121).

On the other hand, when a letter is answered in the master ticket, issue of the authentication ticket is requested from the authentication service 21b using the master ticket (S122).

The authentication service 21b acquires the authentication ticket from the authentication service 21a by requiring issue of the authentication ticket from the authentication service 21a by progressing to step S123 following step S122 (S124).

The authentication service 21b transmits to the authentication management module 13 as that to which oneself published the authentication ticket acquired from the authentication service 21a (S125).

Progressing to step S126 following step S125, the authentication management module 13 creates the new instance corresponding to the authentication ticket published from the authentication service 21b, and outputs the instance handle of the instance which it created to the authentication control module 12 as a response to the authentication request (S116).

Progressing to step S128 (FIG. 16), the authentication control module 12 adds the new entry to the new instance handle to the authentication information table 121.

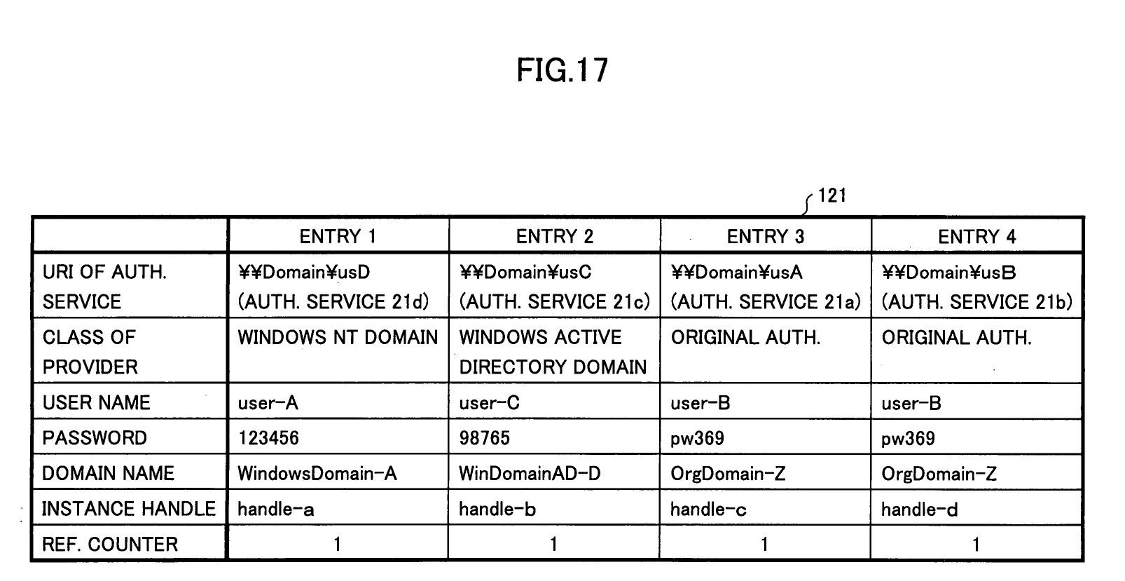

FIG. 17 shows the example of the authentication information table to which the new entry was added.

As shown in FIG. 17, the entry 4 is set as the newly added entry. The entry 3 in which the user name, the password, and the domain name of the entry 4 are reused is copied. The instance handle (instance handle in the entry 4) with the authentication control module 12 new as a response of as opposed to progress to step S129 following step S128, and the authentication request (S105) from application 11b the application it returns to 11b (S129).

The session with document-management service 21b is established by the same procedure as step S68 or subsequent ones (FIG. 11) mentioned above following step S129 after step S130.

If the authentication locations concerned are in the confidential relation even if it is the case where the authentication locations for using each document-management service 31 differ according to the client device 10 in the second preferred embodiment as mentioned above, authentication can be received from the authentication location of another side by reusing the user information at the time of receiving authentication in one authentication location. Therefore, the opportunity to request the input of user information of the user can be reduced.

In addition, in order to clarify more the relation between the processing of FIG. 10 and FIG. 11 in the first preferred embodiment and the processing of FIG. 15 and FIG. 16 in the second preferred embodiment, a description will be given of the processing performed by the authentication control module 12 in response to the authentication request (S17, S55, and S105) from the application 11a or the application 11b.

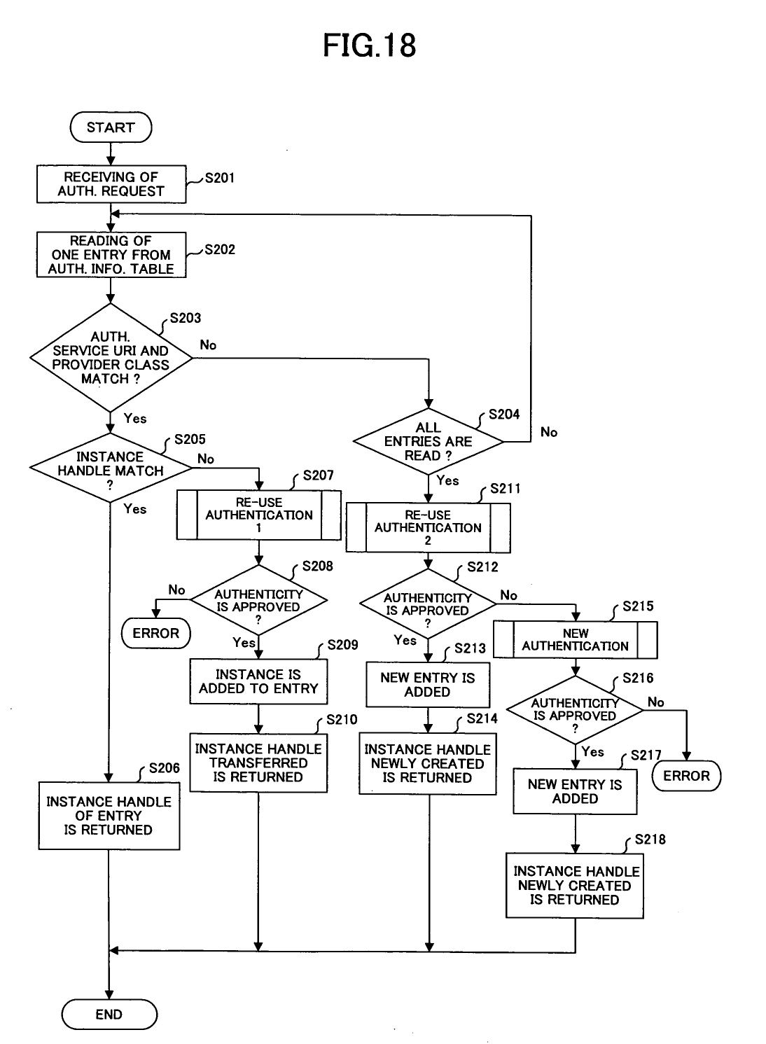

FIG. 18 is a flowchart for explaining the processing of the authentication control module in response to the authentication request from the application.

First, the authentication request from application 11a or application 11b is received (S201). This corresponds to the processing of step S27 (FIG. 6), step S55 (FIG. 10), or step S105 (FIG. 15).

Then, in steps S202 to S205, it is determined whether the authentication is already performed by the authentication service 21, which serves as the authentication location. This corresponds to the processing of step S28, step S56, or step S106.

The entries are read from the authentication information table 121 one by one (S202). It is determined whether the authentication service URI and the authentication provider's classification of each entry are the same as the URI of the authentication service and the classification of the authentication provider which are specified as the authentication location in the authentication request (S203).

When the entry (which is called the “object entry”) having the URI and the classification which are the same as the authentication service URI and the authentication provider's classification specified as the authentication location in the argument of the authentication request is registered in the authentication information table 121. (or Yes at S203), it is further determined whether the instance handle specified as the argument of the authentication request is registered in the object entry (S205). When the result at S205 is affirmative (or when registered), the instance handle is returned as a response to the authentication request (S206).

On the other hand, when the instance handle specified as the argument of the authentication request is NULL and the instance handle concerned is not registered in the object entry (or No at S205), the processing for “reuse authentication 1” is performed (S207). In this case, the processing for “reuse authentication 1” means the processing of steps S57 to S65 (FIG. 10). That is, without displaying the logon screen requesting the user to input the user information, only the authentication is performed based on the user name and password which are registered in the object entry.

When the result of “reuse authentication 1” is affirmative (or Yes at S208), the instance handle is added to the object entry, and the reference counter of the object entry is incremented (S209) (which corresponds to S66 in FIG. 11). And the instance handle which is transferred to is returned as a response to the authentication request (S210).

When the result of “reuse authentication 1” is negative (or No at S208), the result (error) of the authentication is returned as a response to the authentication request.

When there is no more entry having the URI and the classification which are the same as the authentication service URI and the authentication provider's classification specified as the authentication location in the argument of the authentication request in the authentication information table 121 (Yes at S204), the authentication service 21 of the authentication location tries to perform the processing for “reuse authentication 2” (S211), expecting that there is the confidential relation with other authentication services 21.

In this case, the processing for “reuse authentication 2” means the processing of steps S107 to S127 (FIG. 15). That is, without displaying the logon screen requesting the user to input the user information, onlt the authentication is performed based on the user name and password which are registered in the existing entry.

When the result of “reuse authentication 2” is affirmative (or Yes at S212), the new entry is added to the authentication information table 121 (S213) (which corresponds to S128 (FIG. 16)). The instance handle of the newly created instance is returned as a response to the authentication request (S214).

When the result of “reuse authentication 2” is negative (or No at S212), the processing for new authentication is performed (S215). In this case, the processing for new authentication means the processing of steps S19 to S29 (FIG. 6). That is, the logon screen is displayed and authentication is performed based on the user name and password which are inputted into the logon screen by the user.

When the result of the new authentication is affirmative (or Yes at S216), the new entry is added to the authentication information table 121 (S217) (which corresponds to S30 (FIG. 7)), and the instance handle of the newly created instance is returned as a response to the authentication request (S218).

When the result of the new authentication is negative (or No at S216), the result (error) of the authentication is returned as a response to the authentication request.

Thus, one of the processing in the first preferred embodiment and the processing in the second preferred embodiment may be chosen according to the situation. And implementation of one of the two processings does not assure the need of implementation of the other processing.

In addition, the processing at the time of logging off from the document-management server 30a or 30b is not explained in the foregoing. When the logoff is performed, the instance handle of the corresponding instance is deleted from the entry, and the reference counter is decremented. In this case, when the reference counter is reset to 0 (or when any instance does not belong to the entry), the entry concerned may be deleted from the authentication-information management table 121. Alternatively, the authentication-information management table 121 may be left unchanged.

Although the former is advantageous when the storage region is restricted, in the case of the latter, if the authentication is again requested to the authentication location of the entry concerned, the advantages that it is not necessary to request the user to input the user information can be retained.

Moreover, in the above-described embodiment, the application 11a is the plug-in application with which it can be detachable attached to the client application 11. Moreover, as for the application newly added in the state where the entries are already registered the authentication information table 121, it is also possible reuse the user information registered in the entry concerned.

By the way, in recent years, there are provided the information-processing devices which can perform information processing equivalent to the computer, such as that specialized in a certain specific function and the functions as the Web server also incorporated in the device.

For example, among them, there is also the image forming apparatus which is called the multi-function peripheral or compound machine, which has the plurality of applications which perform processing specialized to the multiple services, such as printer, copiee and facsimile. Further, in the latest image forming apparatus, there are some which have the document-management function which accumulates the copied information or the information which carried out FAX reception as document data.

Therefore, using the above-mentioned image forming apparatus, it is possible to constitute the document-management system of the present embodiment, and the effects of the invention can be acquired similarly.

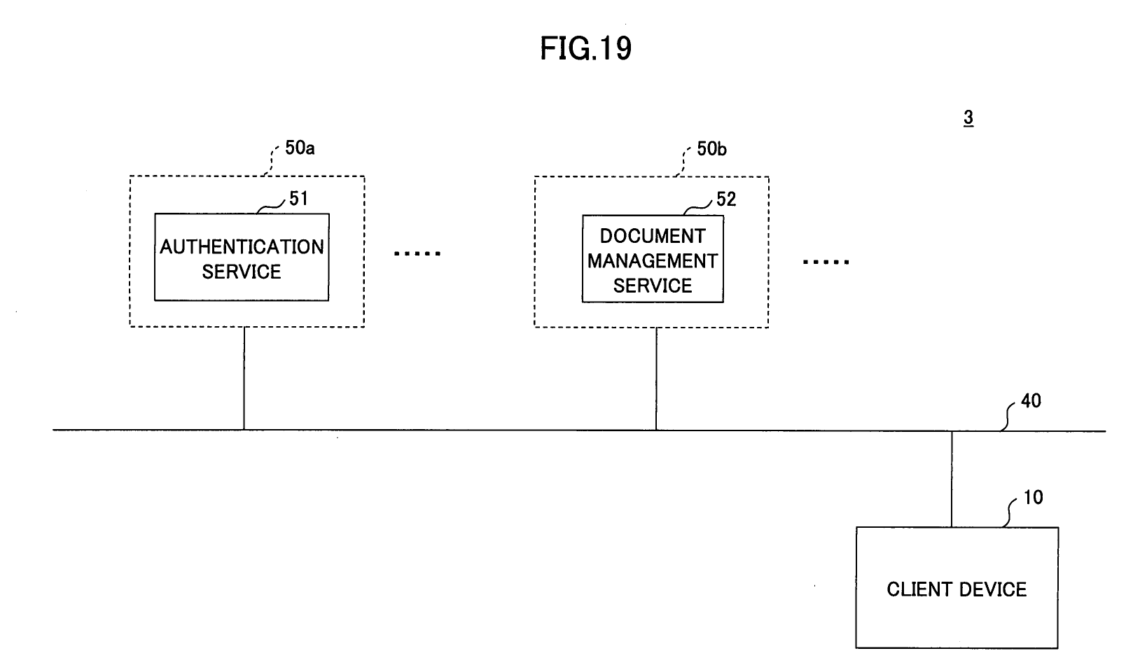

FIG. 19 shows the composition of the document-management system which is constituted using the image forming apparatus.

In FIG. 19, the elements which are the same as corresponding elements in FIG. 2 are designated by the same reference numerals, and a description thereof will be omitted.

As compared with FIG. 2, the document-management system 3 of FIG. 19 comprises the image-forming apparatus 50a and the image-forming apparatus 50b, instead of the authentication server 20 and the document-management server 30, respectively.

The authentication service 51 which is the same as that implemented in the authentication server 20 is implemented in the image-forming apparatus 50a. Moreover, the document-management service 52 which is the same as that implemented in the document-management server 30 is implemented in the image-forming apparatus 50b. Therefore, in this document-management service 3, the functions and effects which are the same as those explained above in the first and second preferred embodiments can be acquired.

The present invention is not limited to the above-described embodiments, and variations and modifications may be made without departing from the scope of the present invention.

Further, the present application is based on Japanese patent application No. 2003-417958, filed on Dec. 16, 2003, and Japanese patent application No. 2004-292812, filed on Oct. 5, 2004, the entire contents of which are hereby incorporated by reference.

1. An information-processing device which is connected through a network to a plurality of external devices which provide predetermined services respectively, and to one or more authentication devices each including an authentication unit which authenticates a user who uses any of the services of the plurality of external devices, the information-processing device comprising:
a plurality of service-provision units providing the user with interfaces to the services of the external devices respectively, the interfaces being mutually different;
an authentication control unit requesting, in response to an authentication request from any of the plurality of service-provision units, the user to input user information for authenticating the user, and transmitting to one of the authentication devices a request for performing an authentication processing based on the user information; and
an authentication-information management unit associating and managing the user information inputted by the user, requesting-device identification information to identify a requesting service-provision unit sending the authentication request to the authentication control unit, and requested-device identification information to identify uniquely the one of the authentication devices to which the authentication control unit transmits the request for performing the authentication processing.

2. The information-processing device according to claim 1 wherein the authentication control unit is configured to determine, in response to the authentication request, whether the authentication processing to authenticate the user is already performed by the authentication unit of the one of the authentication devices by referring to the authentication-information management unit.

3. The information-processing device according to claim 2 wherein the authentication control unit is configured to determine, when the requested-device identification information to identify the one of the authentication devices according to the authentication request is managed by the authentication-information management unit, that the user is authenticated by the authentication unit of the one of the authentication devices.

4. The information-processing device according to claim 3 wherein the authentication control unit is configured so that, when it is determined that the user is already authenticated by the authentication unit according to the authentication request, the authentication control unit does not request the user to input the user information.

5. The information-processing device according to claim 1 wherein the authentication control unit is configured so that, when an authentication request is received which is sent to an authentication device the requested-device identification information of which is managed by the authentication-information management unit, and which authentication request is received from a service-provision unit the requesting-device identification information of which is not associated with said requested-device identification information, the authentication control unit transmits the request for performing the authentication processing to said authentication device.

6. The information-processing device according to claim 1 wherein the authentication control unit is configured so that, when an authentication request is received which is sent to an authentication device the requested-device identification information of which is managed by the authentication-information management unit, and which authentication request is received from a service-provision unit the requesting-device identification information of which is associated with said requested-device identification information, the authentication control unit does not transmit the request for performing the authentication processing to said authentication device.

7. The information-processing device according to claim 1 wherein the authentication control unit is configured so that, when an authentication request being sent to an authentication device the requested-device identification information of which is not managed by the authentication-information management unit is received, the authentication control unit requests the user to input the user information.

8. The information-processing device according to claim 1 wherein the authentication control unit is configured so that, when an authentication request being sent to an authentication device the requested-device identification information of which is not managed by the authentication-information management unit is received, the authentication control unit transmits to said authentication device the request for performing the authentication processing using the user information managed by the authentication-information management unit.

9. The information-processing device according to claim 8 wherein the authentication control unit is configured so that, when the user is authenticated by said authentication device the requested-device identification information of which is not managed by the authentication-information management unit, in response to the request for performing the authentication processing transmitted using the user information managed by the authentication-information management unit, the authentication control unit does not request the user to input the user information.

10. The information-processing device according to claim 8 wherein the authentication control unit is configured so that, when the user is not authenticated by an authentication device, the requested-device identification information of which is not managed by the authentication-information management unit, by using all the user information managed by the authentication-information management unit, the authentication control unit requests the user to input another user information.

11. The information-processing device according to claim 1 wherein the authentication-information management unit is configured to associate and manage the requesting-device identification information identifying a service-provision unit which is the same as the requesting service-provision unit, and the requested-device identification information identifying an authentication device which is the same as the requested authentication device.

12. The information-processing device according to claim 1 wherein the authentication control unit is shared by the plurality of service-provision units.

13. An information-processing system including a plurality of external devices which provide predetermined services respectively, one or more authentication devices each including an authentication unit which authenticates a user who uses any of the services of the plurality of external devices, and an information-processing device which is connected through a network to the plurality of external devices and the one or more authentication devices, the information-processing device comprising:
a plurality of service-provision units providing the user with interfaces to the services of the external devices respectively, the interfaces being mutually different;
an authentication control unit requesting, in response to an authentication request from any of the plurality of service-provision units, the user to input user information for authenticating the user, and transmitting to one of the authentication devices a request for performing an authentication processing based on the user information; and
an authentication-information management unit associating and managing the user information inputted by the user, requesting-device identification information to identify a requesting service-provision unit sending the authentication request to the authentication control unit, and requested-device identification information to identify uniquely the one of the authentication devices to which the authentication control unit transmits the request for performing the authentication processing.

14. The information processing system according to claim 13 wherein the authentication control unit is configured so that, when an authentication request is received which is sent to an authentication device the requested-device identification information of which is managed by the authentication-information management unit, and which authentication request is received from a service-provision unit the requesting-device identification information of which is not associated with said requested-device identification information, the authentication control unit transmits the request for performing the authentication processing to said authentication device.

15. The information processing system according to claim 13 wherein the authentication control unit is configured so that, when an authentication request being sent to an authentication device the requested-device identification information of which is not managed by the authentication-information management unit is received, the authentication control unit transmits to said authentication device the request for performing the authentication processing using the user information managed by the authentication-information management unit.

16. An information-processing method for an information-processing device which is connected through a network to a plurality of external devices which provide predetermined services respectively, and to one or more authentication devices each including an authentication unit which authenticates a user who uses any of the services of the plurality of external devices, the information-processing device comprising a plurality of service-provision units providing the user with mutually difference interfaces to the services of the external devices respectively, the information-processing method comprising the steps of:
requesting, in response to an authentication request from any of the plurality of service-provision units, the user to input user information for authenticating the user:
transmitting to one of the authentication devices a request for performing an authentication processing based on the user information; and
associating the user information inputted by the user, requesting-device identification information to identify a requesting service-provision unit sending the authentication request, and requested-device identification information to identify uniquely the one of the authentication devices to which the request for performing the authentication processing is transmitted, so that the user information, the requesting-device identification information and the requested-device identification information being associated are registered in a predetermined storage region.

17. The information-processing method according to claim 16 further comprising the step of determining, in response to the authentication request, whether the authentication processing to authenticate the user is already performed by the authentication unit of the one of the authentication devices by referring to the predetermined storage region.

18. The information-processing method according to claim 17 further comprising the step of determining, when the requested-device identification information to identify the one of the authentication devices according to the authentication request is managed by the authentication-information management unit, that the user is authenticated by the authentication unit of the one of the authentication devices.

19. The information-processing method according to claim 18 wherein, when it is determined that the user is already authenticated by the authentication unit according to the authentication request, the user is not requested to input the user information.

20. The information-processing method according to claim 16 wherein, when an authentication request is received which is sent to an authentication device the requested-device identification information of which is registered in the predetermined storage region, and which authentication request is received from a service-provision unit the requesting-device identification information of which is not associated with said requested-device identification information, the request for performing the authentication processing is transmitted to said authentication device.

21. The information-processing method according to claim 16 wherein, when an authentication request is received which is sent to an authentication device the requested-device identification information of which is registered in the predetermined storage region, and which authentication request is received from a service-provision unit the requesting-device identification information of which is associated with said requested-device identification information, the request for performing the authentication processing is not transmitted to said authentication device.

22. The information-processing method according to claim 16 wherein, when an authentication request being sent to an authentication device the requested-device identification information of which is not registered in the predetermined region is received, the user is requested to input the user information.

23. The information-processing method according to claim 16 wherein the requesting-device identification information identifying a service-provision unit which is the same as the requesting service-provision unit, and the requested-device identification information identifying an authentication device which is the same as the requested authentication device are associated and registered in the predetermined storage region.

24. A computer program product embodied therein for causing a computer to execute an information-processing method for an information-processing device which is connected through a network to a plurality of external devices which provide predetermined services respectively, and to one or more authentication devices each including an authentication unit which authenticates a user who uses any of the services of the plurality of external devices, the information-processing device comprising a plurality of service-provision units providing the user with mutually difference interfaces to the services of the external devices respectively, the information-processing method comprising the steps of:
requesting, in response to an authentication request from any of the plurality of service-provision units, the user to input user information for authenticating the user:
transmitting to one of the authentication devices a request for performing an authentication processing based on the user information; and
associating the user information inputted by the user, requesting-device identification information to identify a requesting service-provision unit sending the authentication request, and requested-device identification information to identify uniquely the one of the authentication devices to which the request for performing the authentication processing is transmitted, so that the user information, the requesting-device identification information and the requested-device identification information being associated are registered in a predetermined storage region.

25. A computer-readable recording medium embodied therein for causing a computer to execute an information-processing method for an information-processing device which is connected through a network to a plurality of external devices which provide predetermined services respectively, and to one or more authentication devices each including an authentication unit which authenticates a user who uses any of the services of the plurality of external devices, the information-processing device comprising a plurality of service-provision units providing the user with mutually difference interfaces to the services of the external devices respectively, the information-processing method comprising the steps of:
requesting, in response to an authentication request from any of the plurality of service-provision units, the user to input user information for authenticating the user:
transmitting to one of the authentication devices a request for performing an authentication processing based on the user information; and
associating the user information inputted by the user, requesting-device identification information to identify a requesting service-provision unit sending the authentication request, and requested-device identification information to identify uniquely the one of the authentication devices to which the request for performing the authentication processing is transmitted, so that the user information, the requesting-device identification information and the requested-device identification information being associated are registered in a predetermined storage region.
